(19) United States
(12) Patent Application Publication
(10) Pub. No.: US 2015/0168858 A1
(43) Pub. Date: Jun. 18, 2015

(54) Preparing Resin Emulsions

(71) Applicant: Xerox Corporation, Norwalk, CT (US)

(72) Inventors: Shigeng Li, Webster, NY (US); Shigang Qiu, Toronto (CA); Peter V. Nguyen, Webster, NY (US); Linda S. Schriever, Penfield, NY (US); Amy A. Grillo, Rochester, NY (US); Chieh-Min Cheng, Rochester, NY (US)

(73) Assignee: Xerox Corporation, Norwalk, CT (US)

(21) Appl. No.: 14/107,930

(22) Filed: Dec. 16, 2013

(51) Int. Cl. G03G 9/08; C08L 67/02

(52) U.S. Cl. CPC G03G 9/0802; C08L 67/02

(57) ABSTRACT

A process for making a latex emulsion suitable for use in a toner composition which applies the model of Brinkman to predict phase inversion point (PIP) during phase invention emulsification (PIE), including using this model to calculate the amount of water needed to complete the phase inversion for solvent reuse formulation.

### FIELD

The present disclosure relates to phase inversion emulsification (PIE) processes for producing resin emulsions useful in making toners, more specifically, a process applying the Brinkman model for the viscosity of solutions and suspensions to predict the phase inversion point (PIP) during PIE for the conversion of resins to latexes, including that the model allows for estimation of the amount of water needed to complete phase inversion.

### BACKGROUND

Latex emulsions of resins may be produced using solvent-reuse PIE process in which resins are dissolved in a mixture of water and organic sovlent(s) (e.g., methyl ethyl ketone (MEK), isopropyl alcohol (IPA) or both) from a previous PIE batch to forma homogenous water-in-oil (W/O) dispersion (i.e., water droplets dispersed in continuous oil). Subsequently, water is added to convvert the dispersion into a self-stabilized oil-in-water (O/W) latex.

Organic solvent(s) are moved and surfactant and/or other reagents, such as, preservatives, may be added to provide a stable latex with relatively high solid content of the resin. Such latex may be used for many purposes including the application of Emulsion Aggregation (EA) methods for the production of toner particles (see, e.g., U.S. Pat. Nos. 5,853,943, 5,902,710; 5,910,387; 5,916,725; 5,919,595; 5,925,488, 5,977,210 and 5,994,020, and U.S. Pub. No. 2008/0107989, the disclosure of each of which hereby is incorporated by reference in entirety).

Conversion cost of resins to latex highly influences the cost of producing EA toners. It would be advantageous to develop processes which reduce conversion cycle time, and thus cost, without affecting the performance parameters of the resulting latex (e.g., particle size and particle size distribution).

### SUMMARY

The instant disclosure describes a process for making a latex emulsion suitable for use in a toner composition which applies the model of Brinkman (J Chem Phy (1952) 20:571) to obtain an expression for the viscosity of solutions and suspensions of finite concentration derived by considering the effect of the addition of one solute molecule to an existing solution, which is considered a continuous medium, to predict the phase inversion point (PIP) during phase inversion emulsification (PIE). using that model, the amount of water needed to complete phase inversion may be estimated.

In embodiments, a method of PIE is disclosed including:

a) combining a resin, at least one organic solvent, an optional first portion of a neutralizing agent, and a first portion of water to form a water-in-oil (W/O) dispersion mixture;

b) determining an amount of a second portion of water to add to the mixture to effect phase inversion by:
(i) calculating the Viscosity Blending Number or Index (VBN) for each component of the mixture using equation 1 (eq. 1):

VBN=14.534×1n [1n(ν+0.8)]+10.975 (eq. 1),
where ν is the kinematic viscosity in centistokes (cSt);
(ii) calculating the VBN of the mixture using equation 2 (eq. 2):

VBNₘᵢₓₜᵤᵣₑ=[X_{A}×VBN_{A}]+[X_{B}×VBN_{B}]+ . . . [X_{N}×VBN_{N}] (eq. 2),
where X is the mass fraction of each component of the mixture,
(iii) calculating the kinematic viscosity of the blend by solving eq. 1 for ν resulting in equation 3 (eq. 3), and

$$v = exp ( exp ( \frac{{VEN}_{mixture} - \text{?}}{\text{?}} ) ) - 0.8 , \\ \text{?} \text{indicates text missing or illegible when filed} \qquad ( eq . 3 )$$

(iv) calculating the water fraction at the maximum VBNₘᵢₓₜᵤᵣₑ for the mixture using equation 4 (eq. 4);

$$\text{?} = \text{?} , \\ \text{?} \text{indicates text missing or illegible when filed} \qquad ( eq . 4 )$$

where μ_{φ} is the viscosity of the dispersed phase of the mixture, μ_{c} is the viscosity of the continuous phase of the mixture, which is equal to the VBNₘᵢₓₜᵤᵣₑ, and Φ is the water fraction of the mixture, where the calculated is the sum of the first portion of water, any water portion of the optional neutralizing agent and a second portion of water, where the total amount is the amount of water needed to attain the PIP for the mixture; and
c) adding the second portion of water determined from the total amount of water to the mixture to meet the calculated Φ,
   where the addition of the second portion of water coverts the W/O dispersion mixture comprising the resin into an oil-in-water (O/W) dispersion comprising a latex emulsion.

In embodiments, a method of preparing a toner is disclosed including:

a) combining a resin, at least one organic solvent, an optional first portion of a neutralizing agent and a first portion of water to form a W/O dispersion mixture;

b) determining an amount of a second portion of water to add to the mixture to effect phase inversion by:
(i) calculating the Viscosity Blending Number or Index (VBN) for each component of the mixture using equation 1 (eq. 1):

VBN=14.534×1n [1n(ν+0.8)]+10.975 (eq. 1),
where ν is the kinematic viscosity in centistokes (cSt);
(ii) calculating the VBN of the mixture as a function of increasing water fraction using equation 2 (eq. 2):

VBNₘᵢₓₜᵤᵣₑ=[X_{A}×VBN_{A}]+[X_{B}×VBN_{B}]+ . . . [X_{N}×VBN_{N}] (eq. 2),
where X is the mass fraction of each component of the mixture,
(iii) calculating the kinematic viscosity of the blend by solving eq. 1 for ν resulting in equation 3 (eq. 3), and

$$v = exp ( exp ( \frac{{VEN}_{mixture} - \text{?}}{\text{?}} ) ) - 0.8 , \\ \text{?} \text{indicates text missing or illegible when filed} \qquad ( eq . 3 )$$

(iv) calculating the water fraction at the maximum VBNₘᵢₓₜᵤᵣₑ for the mixture using equation 4 (eq. 4):

$$\text{?} = \text{?} , \\ \text{?} \text{indicates text missing or illegible when filed} \qquad ( eq . 4 )$$

μ_{φ} is the viscosity of the dispersed phase of the mixture, μ_{c} is the viscosity of the continuous phase of the mixture, which is equal to the VBNₘᵢₓₜᵤᵣₑ, and Φ is the water fraction of the mixture, where the calculated Φ is the sum of the first portion of water, any water portion of the optional neutralizing agent and a second portion of water, where the total amount is the amount of water needed to attain the PIP for the mixture;

c) adding the second portion of water to the mixture to meet the calculated Φ, where the addition of the second portion of water converts the W/O dispersion mixture comprising the resin into and O/W dispersion comprising a latex emulsion;

d) adding an optional at least a second amorphous resin to said emulsion;

e) optionally adding a crystalline resin to said emulsion;

f) optionally adding a wax, a colorant or both to said emulsion;

g) optionally adding a flocculent to the emulsion;

h) aggregating particles in said emulsion;

i) freezing particle growth in said emulsion to form frozen particles;

j) optionally adding a shell resin;

k) optionally coalescing said frozen particles in said emulsion to form toner particles; and

l) collecting said frozen particles or said toner particles from said emulsion.

### DETAILED DESCRIPTION

Polyester resins are important for controlling the fusing properties of ultra low melt (ULM) toners. To make ULM toners, those polyester resins must first be converted into latexes with certain particle size and particle size distribution, while maintaining the resin properties.

Polyester latexes may be produced using solvent reuse formulation to complete PIE. In the process, the polyester resin may be dissolved in a mixture of, for example, dual solvents (e.g., methyl ethyl ketone (MEK) and isopropanol (IPA)), distilled (DI) water and optionally a base, such as, ammonia. A small quantity of base may be used to partially neutralize the polyester to promote resin dispersion within the mixture of organic solvents and DI water. A second quantity of base may then be added to the homogenous resin dissolution to neutralize further the acid end groups on the polyester chains, followed by the addition of a second quantity of DI water to generate a uniform suspension of polyester particles in a water continuous phase via phase inversion.

Analysis in a stirred vessel demonstrated that for PIE, the drop size increased significantly near phase inversion, while secondary droplets were formed. While not being bound by theory, it seems that the phase inversion process includes the break-up and coalescence process of droplets corresponding to the formation of double emulsions. Brinkman (supra) applied a slightly different approach by accounting for the incremental change in viscosity due to the addition of one extra solute particle to a dispersion of known concentration deriving equation 4 (eq. 4):

$$\text{?} = \text{?} \\ \text{?} \text{indicates text missing or illegible when filed} \qquad ( eq . 4 )$$

In that equation, μ_{φ} represents the viscosity of the dispersed phase and μ_{c} is the viscosity of the continuous phase, respectively, where Φ is the water fraction. Since there is no assumption on the shape and size of the droplets, that model allows for polydispersity, but interactions between adjacent particles when closely packed are not considered.

While not being bound by theory, phase inversion takes place at the phase fraction where the difference in viscosity between the oil continuous and the water continuous dispersions become substantially equivalent. The Brinkman model was found to have the best agreement with experimental data of oil/water systems of different oil viscosities regardless of mixture viscosity and dispersion initialization.

The PIE reuse formulation represents the double emulsion process discussed above. while not being bound by theory, the solvent continuous phase eventually becomes the dispersed phase in the water continuous phase, while the added water droplets appear in the solvent drops and dominate the continuous phase. In embodiments, the model is used to predict the PIP of a PIE process.

As disclosed herein, since the latex particle is stable after PIP is reached, PIE productivity may be improved by taking advantage of that characteristic; i.e., identify the PIP and reduce cycle time by increasing the water feeding rate according to the formulation.

While not being bound by theory, it seems that several parameters affect the phase inversion process, however, the viscosities of the phases, in particular, and consequently the dispersion mixture viscosity, appear to dominate the PIE process. The mixture viscosity is related to the pressure gradient which drives the dispersion. Therefore, as disclosed herein, mixture viscosity is suggested to be an important parameter for prediction of the PIE process.

The viscosity of a dual-solvent mixture may be calculated by Refutas equation. The calculation is carried out in the following steps:
(i) calculating the VBN for each component of the mixture using equation 1 (eq. 1):

VBN=14.534×1n [1n(ν+0.8)]+10.975 (eq. 1),
where ν is the kinematic viscosity in centistokes (cSt);
(ii) calculating the VBN of the mixture using equation 2 (eq. 2):

VBNₘᵢₓₜᵤᵣₑ=[X_{A}×VBN_{A}]+[X_{B}×VBN_{B}]+ . . . [X_{N}×VBN_{N}] (eq. 2),
where X is the mass fraction of each component of the mixture,
(iii) calculating the kinematic viscosity of the blend by solving eq. 1 for ν resulting in equation 3 (eq. 3), and

$$v = exp ( exp ( \frac{{VEN}_{mixture} - \text{?}}{\text{?}} ) ) - 0.8 , \\ \text{?} \text{indicates text missing or illegible when filed} \qquad ( eq . 3 )$$

(iv) calculating the water fraction at the maximum VBNₘᵢₓₜᵤᵣₑ for the mixture using equation 4 (eq. 4):

$$\text{?} = \text{?} , \\ \text{?} \text{indicates text missing or illegible when filed} \qquad ( eq . 4 )$$

where μ_{φ} is the viscosity of the dispersed phase of the mixture, μ_{c} is the viscosity of the continuous phase of the mixture, which is equal to the VBNₘᵢₓₜᵤᵣₑ and Φ is the water fraction of the mixture, where the calculated Φ is the sum of the first portion of water, any water portion of the optional neutralizing agent and a second portion of water, where the total amount is the amount of water needed to attain the PIP for the mixture.

Using certain solvents and emulsions reagents, data can be accumulated to form charts or tables that correlate combinations of reagents and solvents with the water fraction needed in the emulsion to achieve PIP. The water fraction represents the total amount of water added to the emulsion. Generally, the amount of water added by solutions of reagents may be small and not material, however, the amounts of water contributed from all sources can be considered for determining the water fraction and the first and second portions added during the PIE process. Hence, the table serves as a reference to ascertain water amount to achieve an O/W emulsion comprising latex particles using the certain reagents, such as, a resin or resins, and an organic solvent or solvents.

Unless otherwise indicated, all numbers expressing quantities and conditions, and so forth used in the specification and claims are to be understood as being modified in all instances by the term, “about.” “About,” is meant to indicate a variation of no more than 10% from the stated value. Also used herein is the term, “equivalent,” “similar,” “essentially,” “substantially,” “approximating,” and, “matching,” or grammatic variations thereof, have generally acceptable definitions or at the least, are understood to have the same meaning as, “about.”

Currently, ULM polyester toners result in a benchmark Minimum Fix Temperature (MFT) which is reduced by about 20° C. as compared to conventional EA toners. In embodiments, an ULM toner of the present disclosure may have an MFT of from about 100° C. to about 130° C., from about 105° C. to about 125° C., from about 110° C. to about 120° C.

Resins

Any resin may be utilized in forming a latex emulsion of the present disclosure. The resins may be an amorphous resin, a crystalline resin, and/or a combination thereof. The resin may be a polyester resin, including the resins described, for example, in U.S. Pat. Nos. 6,593,049 and 6,756,176, the disclosure of each of which hereby is incorporated by reference in entirety. Suitable resins also may include a mixture of an amorphous polyester resin and a crystalline polyester resin as described in U.S. Pat. No. 6,830,860, the disclosure of which is hereby incorporated by reference in entirety. Suitable resins may include a mixture of high molecular and low molecular weight amorphous polyester resins.

The resin may be a polyester resin formed by reacting a diol with a diacid in the presence of an optional catalyst.

The diol may be, for example, selected in an amount of from about 40 to about 60 mole percent, from about 42 to about 55 mole percent, from about 45 to about 53 mole percent, and optionally, a second diol can be selected in an amount of from about 0 to about 10 mole percent, from about 1 to about 4 mole percent of the resin. The diacid may be selected in an amount of, for example, from about 40 to about 60 mole percent, from about 42 to about 52 mole percent, from about 45 to about 50 mole percent, and optionally, a second diacid may be selected in an amount of from about 0 to about 10 mole percent of the resin.

Examples of crystalline resins include polyesters, polyamides, polyimides, polyolefins, polyethylene, polybutylene, polyisobutyrate, ethylene-propylene copolymers, ethylene-vinyl acetate copolymers, polypropylene, mixtures thereof, and the like. Specific crystalline resins may be polyester based, such as poly(ethylene-adipate), poly(propylene-adipate), poly(butylene-adipate), poly(pentylene-adipate), poly(hexylene-adipate), poly(octylene-adipate), poly(ethylene-succinate), poly(propylene-succinate), poly(butylene-succinate), poly(pentylene-succinate), poly(hexylene-succinate), poly(octylene-succinate), poly(ethylene-sebacate), poly(propylene-sebacate), poly(butylene-sebacate), poly(pentylene-sebacate), poly(hexylene-sebacate), poly(octylene-sebacate), poly(decylene-sebacate), poly(decylene-decanoate), poly(ethylene-decanoate), poly(ethylene dodecanoate), poly(nonylene-sebacate), poly(nonylene-decanoate), copoly(ethylene-fumarate)-copoly(ethylene-sebacate), copoly(ethylene-fumarate)-copoly(ethylene-decanoate), copoly(ethylene-fumarate)-copoly(ethylene-dodecanoate), copoly(2,2-dimethylpropane-1,3-diol-decanoate)-copoly(nonylene-decanoate), poly(octylene-adipate). Examples of polyamides include poly(ethylene-adipamide), poly(propylene-adipamide), poly(butylenes-adipamide), poly(pentylene-adipamide), poly(hexylene-adipamide), poly(octylene-adipamide), poly(ethylene-succinimide), and poly(propylene-sebecamide). Examples of polyimides include poly(ethylene-adipimide), poly(propylene-adipimide), poly(butylene-adipimide), poly(pentylene-adipimide), poly(hexylene-adipimide), poly(octylene-adipimide), poly(ethylene-succinimide), poly(propylene-succinimide) and poly(butylene-succinimide).

The crystalline resin may be present, for example, in an amount of from about 1 to about 50 percent by weight of the toner components, from about 5 to about 35 percent by weight of the toner components. The crystalline resin may possess various melting points of, for example, from about 30° C. to about 120° C., from about 50° C. to about 90° C. The crystalline resin may have a number average molecular weight (Mn), as measured by gel permeation chromatography (GPC) of, for example, from about 1,000 to about 50,000, from about 2,000 to about 25,000, and a weight average molecular weight (Mw) of, for example, from abut 2,000 to about 100,000, from about 3,000 to about 80,000, as determined by GPC. The molecular weight distribution (Mw/Mn) of the crystalline resin may be, for example, from about 2 to about 6, from about 3 to about 4.

Polycondensation catalysts may be utilized in forming either the crystalline or amorphous polyesters and include tetraalkyl titanates, dialkyltin oxides, such as, dibutyltin oxide, tetraalkyltins, such as, dibutyltin dilaurate, and dialkyltin oxide hydroxides, such as, butyltin oxide hydroxide, aluminum alkoxides, alkyl zinc, dialkyl zinc, zinc oxide, stannous oxide or combinations thereof. Such catalysts may be utilized in amounts of, for example, from about 0.01 mole percent to about 5 mole percent based on the starting diacid or diester used to generate the polyester resin.

Other suitable resins that can be used to make toner comprise a styrene, an acrylate, such as, an alkyl acrylate, such as, methyl acrylate, ethyl acrylate, butyl acrylate, isobutyl acrylate, dodecyl acrylate, n-octyl acrylate, n-butylacrylate, 2-chloroethyl acrylate; β-carboxy ethyl acrylate (β-CEA), phenyl acrylate, methacrylate, butadienes, isoprenes, acrylic acids, acrylonitriles, styrene acrylates, styrene butadienes, styrene methacrylates, and so on, such as, methyl α-chloroacrylate, methyl methacrylate, ethyl methacrylate, butyl methacrylate, butadiene, isoprene, methacrylonitrile, acrylonitrile, vinyl ethers, such as, vinyl methyl ether, vinyl isobutyl ether, vinyl ethyl ether and the like; vinyl esters, such as, vinyl acetate, vinyl propionate, vinyl benzoate and vinyl butyrate; vinyl ketones, such as, vinyl methyl ketone, vinyl hexyl ketone, methyl isopropenyl ketone and the like; vinylidene halides, such as, vinylidene chloride, vinylidene chlorofluoride and the like; N-vinyl indole, N-vinyl pyrrolidone, methacrylate, acrylic acid, methacrylic acid, acrylamide, methacrylamide, vinylpyridine, vinylpyrrolidone, vinyl-M-methylpyridinium chloride, vinyl naphthalene, p-chlorostyrene, vinyl chloride, vinyl bromide, vinyl fluoride, ethylene, propylene, butylene, isobutylene and mixtures thereof. A mixture of monomers can be used to make a copolymer, such as, a block copolymer, an alternating copolymer, a graft copolymer and so on.

An amorphous resin or combination of amorphous resins utilized in the latex may have a glass transition temperature (Tg) of from about 30° C. to about 80° C., from about 35° C. to about 70° C. In embodiments, the combined resins utilized in the latex may have a melt viscosity of from about 10 to about 1,000,000 Pa*S at about 130° C., from about 50 to about 100,000 Pa*S at about 130° C.

One, two or more resins may be used. In embodiments, where two or more resins are used, the resins may be in any suitable ratio (e.g., weight ratio), such as, of from about 1% (first resin)/99% (second resin) to about 99% (first resin)/1% (second resin), in embodiments, from about 10% (first resin)/90% (second resin) to about 90% (first resin)/10% (second resin).

In embodiments, a suitable toner of the present disclosure may include two amorphous polyester resins and a crystalline polyester resin. The weight ratio of the three resins may be from about 30% first amorphous resin/65% second amorphous resin/5% crystalline resin, to about 60% first amorphous resin/20% second amorphous resin/20% crystalline resin.

In embodiments, a suitable toner of the present disclosure may include at least two amorphous polyester resins, a high molecular weight resin and a low molecular weight resin. As used herein, a high molecular weight (HMW) amorphous resin may have a weight average molecular weight (Mw) of from about 35,000 to about 150,000, from about 45,000 to about 140,000, and a low molecular weight (LMW) amorphous resin may have an Mw of from about 10,000 to about 30,000, from about 15,000 to about 25,000.

The weight ratio of the two resins may be from about 10% first amorphous resin/90% second amorphous resin, to about 90% first amorphous resin/10% second amorphous resin.

In embodiments, the resin may possess acid groups which, in embodiments, may be present at the terminal of the resin. Acid groups, which may be present, include carboxylic acid groups, and the like. The number of acid groups may be controlled by adjusting the materials utilized to form the resin and reaction conditions.

In embodiments, the resin may be a polyester resin having an acid number from about 2 mg KOH/g of resin to about 200 mg KOH/g of resin, from about 5 mg KOH/g of resin to about 50 mg KOH/g of resin, from about 10 mg KOH/g of resin to about 15 mg KOH/g of resin. The acid-containing resin may be dissolved in, for example, a tetrahydrofuran solution. The acid number may be detected by titration with KOH/methanol solution containing phenolphthalein as the indicator.

The resin particles of interest are no greater than 100 nm in size, that is, are 100 nm or smaller, such as, 99 nm, 98 nm, 97 nm, 96 nm, 95 nm or smaller in size. Thus, resin particles of interest are less than 100 nm in size.

Solvent

Any suitable organic solvent may be used to dissolve the resin, for example, alcohols, esters, ethers, ketones, amines and combinations thereof, in an amount of, for example, from about 30% by weight to about 400% by weight of the resin, from about 40% by weight to about 250% by weight of the resin, from about 50% by weight to about 100% by weight of the resin.

In embodiments, suitable organic solvents, sometimes referred to herein, in embodiments, as phase inversion agents, include, for example, methanol, ethanol, propanol, IPA, butanol, ethyl acetate, MEK and combinations thereof. In embodiments, the organic solvent may be immiscible in water and may have a boiling point of from about 30° C. to about 120° C. In embodiments when at least two solvents are used, the ratio of solvents can be from about 1:2 to about 1:15, from about 1:2.5 to about 1:12.5, from about 1:3 to about 1:10, from about 1:3.5 to about 1:7.5. Thus, if the first solvent is IPA and the second solvent is MEK, the ratio of IPA to MEK can be, for example, about 1:4.

Neutralizing Agent

In embodiments, the resin optionally may be mixed with a weak base or a neutralizing agent. In embodiments, the neutralizing agent may be used to neutralize acid groups in the resins, so a neutralizing agent herein may also be referred to as a, “basic neutralization agent.” Any suitable basic neutralization reagent may be used in accordance with the present disclosure. In embodiments, suitable basic neutralization agents may include both inorganic basic agents and organic basic agents. Suitable basic agents may include ammonium hydroxide, potassium hydroxide, sodium hydroxide, sodium carbonate, sodium bicarbonate, lithium hydroxide, potassium carbonate, combinations thereof and the like. Suitable basic agents may also include monocyclic compounds and polycyclic compounds having at least one nitrogen atom, such as, for example, secondary amines, which include aziridines, azetidines, piperazines, peiperidines, pyridines, bipyridines, terpyridines, dihydropyridines, morpholines, N-alkylmorpholines, 1,4-diazabicyclo[2.2.2]octanes, 1,8-diazabicycloundecanes, 1,8-diazabicycloundecenes, dimethylated pentylamines, trimethylated pentylamines, pyrimidines, pyrroles, pyrrolidines, pyrrolidinones, indoles, indolines, indanones, benzindazones, imidazoles, benzimidazoles, imidazolones, imidazolines, oxazoles, isoxazoles, oxazolines, oxadiazoles, thiadiazoles, carbazoles, quinolines, isoquinolines, naphthyridines, triazines, triazoles, tetrazoles, pyrazoles, pyrazolines and combinations thereof. In embodiments, the monocyclic and polycyclic compounds may be unsubstituted or substituted at any carbon position on the ring.

In embodiments, an emulsion formed in accordance with the present disclosure includes a small quantity of water, in embodiments, de-ionized water (DIW) in amounts and at temperatures that melt or soften the resin, of from about 25° C. to about 120° C., from about 35° C. to about 80° C.

The basic agent may be utilized in an amount of from about 0.001% by weight to 50% by weight of the resin, from about 0.01% by weight to about 25% by weight of the resin, from about 0.1% by weight to 5% by weight of the resin. In embodiments, the neutralizing agent may be added in the form of an aqueous solution. In embodiments, the neutralizing agent may be added in the form of a solid. In embodiments, plural forms of bases are used in a process of interest. Hence, a process can comprise a first base, and at a different or successive step, a second base is used. The first and second bases can be the same or different.

Utilizing the above basic neutralization agent in combination with a resin possessing acid groups, a neutralization ratio of from about 25% to about 300% may be achieved, from about 50% to about 200%. In embodiments, the neutralization ratio may be calculated as the molar ratio of basic groups provided with the basic neutralizing agent to the acid groups present in the resin multiplied by 100%.

As noted above, the basic neutralization agent may be added to a resin possessing acid groups. The addition of the basic neutralization agent may thus raise the pH of an emulsion including a resin possessing acid groups from about 5 to about 12, from about 6 to about 11. The neutralization of the acid groups may, in embodiments, enhance formation of the emulsion.

Surfactants

In embodiments, the process of the present disclosure may optionally include adding a surfactant, for example, before or during combining reagents, to the resin at an elevated temperature, in an emulsion, in a dispersion and so on. The surfactant may be added prior to mixing the resin at an elevated temperature.

Where utilized, a resin emulsion may include one, two or more surfactants. The surfactants may be selected from ionic surfactants and nonionic surfactants. Anionic surfactants and cationic surfactants are encompassed by the term, “ionic surfactants,” In embodiments, the surfactant may be added as a solid or as a solution with a concentration of from about 5% to about 100% (pure surfactant) by weight, in embodiments, from about 10% to about 95% by weight. In embodiments, the surfactant may be utilized so that it is present in an amount of from about 0.01% to about 20% by weight of the resin, from about 0.1% to about 16% by weight, from about 1% to about 14% by weight of the resin.

Processing

The present process comprises forming a mixture by any known means, optionally, at an elevated temperature above room temperature, containing at least one resin, at least one organic solvent, optionally a surfactant, and optionally a neutralizing agent to form a latex emulsion. In embodiments, the resins may be pre-blended prior to combining or mixing.

In embodiments, the elevated temperature may be a temperature near to or above the T_{g} of the resin(s). In embodiments, the resin may be a mixture of low and high molecular weight amorphous resins.

Thus, in embodiments, a process of the present disclosure may include contacting at least one resin with an organic solvent to form a resin mixture, heating the resin mixture to an elevated temperature, stirring the mixture, optionally adding a neutralizing agent to neutralize the acid groups of the resin, adding water in two portions into the mixture until phase inversion occurs to form a phase inversed latex emulsion, distilling the latex to remove a water solvent mixture in the distillate and producing a latex, such as, with a low polydispersity, a lower percentage of fines, coarse particles, and so on.

In the phase inversion process, resin, such as, an amorphous and/or a combination of at least one amorphous and crystalline polyester resins may be dissolved in a low boiling point organic solvent, which solvent is miscible or partially miscible in water, such as, MEK and any other solvent noted hereinabove, at a concentration of from about 1% by weight to about 75% by weight resin in solvent, from about 5% by weight to about 60% by weight resin in solvent. The resin mixture is then heated to a temperature of from about 25° C. to about 90° C., from about 30° C. to about 85° C. The heating need not be held at a constant temperature, but may be varied. For example, the heating may be slowly or incrementally increased until a desired temperature is achieved.

In accordance with processes as disclosed, a latex may be obtained using a more than one solvent PIE process which requires dispersing and solvent stripping steps. In that process, the resin may be dissolved in a combination of more than one organic solvents, for example, MEK and IPA, to produce a uniform organic phase.

An amount of a base solution (such as, ammonium hydroxide) may be added into the organic phase to neutralize acid end groups of the resin.

Water is added in two portions to form a uniform dispersion of resin particles in water through phase inversion.

The organic solvents remain in both the resin particles and water phase at that state. Through vacuum distillation, for example, the organic solvents can be stripped, albeit in what can be a lengthy procedure.

In embodiments, the resin to two or more solvents (for example, MEK and IPA) ratios may be from about 10:8 to about 10:12, from about 10:8.5 to about 10:11.5, from about 10:9 to about 10:11. When two solvents are used, and an LMW resin is included, the ratio of the LMW resin to the first and to the second solvents can be from about 10:6:1.5 to about 10:10:2.5. When an HMW resin is included with two solvents, the ratio of the HMW resin to the first and to the second solvents can be from about 10:8:2 to about 10:11:3, although amounts outside of those ranges noted above can be used.

In embodiments, the neutralizing agent includes the agents mentioned hereinabove. In embodiments, a surfactant may or may not be added to the resin, where the surfactant when utilized may be any of the surfactants mentioned hereinabove to obtain a latex with lower coarse content, where a coarse particle is greater than 100 nm in size.

In embodiments, the optional surfactant may be added to the one or more ingredients of the resin composition before, during or after mixing. In embodiments, the surfactant may be added before, during or after addition of the neutralizing agent. In embodiments, the surfactant may be added prior to the addition of the neutralizing agent. In embodiments, a surfactant may be added to the pre-blend mixture.

The mixing temperature may be from about 35° C. to about 100° C., from about 40° C. to about 90° C., from about 50° C. to about 70° C.

Once the resins, optional neutralizing agent and optional surfactant are combined, the mixture may then be contacted with a first portion of a water, to form a W/O emulsion. Water may be added to form a latex with a solids content of from about 5% to about 60%, from about 10% to about 50%. While higher water temperatures may accelerate dissolution, latexes may be formed at temperatures as low as room temperature (RT). In embodiments, water temperatures may be from about 40° C. to about 110° C., from about 50° C. to about 90° C.

The amount of water comprising the first portion of water is an amount suitable to form a W/O emulsion. Phase inversion can occur at about a 1:1 w/w or v/v ratio of organic phase to aqueous phase. Hence, the first portion of water generally comprises less than about 50% of the total volume or weight of the final emulsion. The first portion of water can be less than about 95% of the volume or weight of the organic phase, less than about 90%, less than about 85%, less than about 80% of the volume or weight of the organic phase. Lower amounts of water can be used in the first portion so long as a suitable W/O emulsion is formed.

Phase inversion occurs on adding an optional aqueous alkaline solution or basic agent, optional surfactant and second portion of water to create a phase inversed emulsion including a dispersed phase including droplets possessing the molten ingredients of the resin composition and a continuous phase including the surfactant and/or water composition, where the second portion of water to attain PIP is determined as taught herein.

Combining may be conducted, in embodiments, utilizing any means within the purview of those skilled in the art. For example, combining may be conducted in a glass kettle with an anchor blade impeller, an extruder, i.e., a twin screw extruder, a kneader, such as, a Haake mixer, a batch reactor or any other device capable of intimately mixing viscous materials to create near or homogenous mixtures.

Stirring, although not necessary, may be utilized to enhance formation of the latex. Any suitable stirring device may be utilized. In embodiments, the stirring may be at a speed of from about 10 revolutions per minute (rpm) to about 5,000 rpm, from about 20 rpm to about 2,000 rpm, from about 50 rpm to about 1,000 rpm. The stirring need not be at a constant speed and may be varied. For example, as the heating of the mixture becomes more uniform, the stirring rate may be increased. In embodiments, a homogenizer (that is, a high shear device), may be utilized to form the phase inversed emulsion, in embodiments, the process of the present disclosure may take place without the use of a homogenizer. Where utilized, a homogenizer may operate at a rate of from about 3,000 rpm to about 10,000 rpm.

Although the point of phase inversion may vary depending on the components of the emulsion, the temperature of heating, the stirring speed, and the like, phase inversion may occur when the optional basic neutralization agent, optional surfactant, and water are added so that the resulting resin is present in an amount from about 5% by weight to about 70% by weight of the emulsion, from about 20% by weight to about 65% by weight, from about 30% by weight to about 60% by weight of the emulsion.

Following phase inversion, additional optional surfactant, water, and optional aqueous alkaline solution may be added to dilute the phase inversed emulsion, although not required. Following phase inversion, the inversed emulsion may be cooled to room temperature, for example from about 20° C. to about 25° C.

In embodiments, distillation with stirring of the organic solvent may be performed to provide resin emulsion particles with an average diameter size of less than 100 nm, less than about 95 nm, less than about 90 nm.

The desired properties of the resin emulsion (i.e., particle size and low residual solvent level) may be achieved by adjusting the solvent and neutralizer concentration and process parameters (i.e., reactor temperature, vacuum and process time).

The coarse content of the latex of the present disclosure, that is, particles that are larger than most prevalent or desired population of particles, may be from about 0.01% by weight to about 5% by weight, from about 0.1% by weight to about 3% by weight. The solids content of the latex of the present disclosure may be from about 10% by weight to about 60%, from about 20% by weight to about 50% by weight.

Toner

Once the resin mixture has been contacted with water to form an emulsion and the solvent removed from the mixture as described above, the resulting latex may then be utilized to form a toner by any method within the purview of those skilled in the art. The latex emulsion may be contacted with an optional colorant, optionally in a dispersion, and other additives to form an ultra low melt toner by a suitable process, in embodiments, an emulsion aggregation and coalescence process.

In embodiments, the optional additional ingredients of a toner composition including optional colorant, wax and other additives, may be added before, during or after melt mixing the resin to form the latex emulsion of the present disclosure. The additional ingredients may be added before, during or after formation of the latex emulsion. In embodiments, the colorant may be added before the addition of the surfactant.

Colorants

One or more colorants may be added, and various known suitable colorants, such as dyes, pigments, mixtures of dyes, mixtures of pigments, mixtures of dyes and pigments, and the like, may be included in the toner. In embodiments, the colorant, when present, may be included in the toner in an amount of, for example, 0 to about 35% by weight of the toner, from about 1 to about 25% by weight of the toner, from about 3 to about 5% by weight of the toner, although the amount of colorant can be outside of those ranges, such as, about 7%, about 7.5%, about 8% by weight of the toner.

As examples of suitable colorants, mention may be made of carbon black like REGAL 330® (Cabot), Carbon Black 5250 and 5750 (Columbian Chemicals), Sunsperse Carbon Black LHD 9303 (Sun Chemicals); magnetites, such as Mobay magnetites MO8029™, MO8060™; Columbian magnetites; MAPICO BLACKS™ and surface treated magnetites; Pfizer magnetites CB-4799™, CB5300™, CB5600™, MCX6369™; Bayer magnetites, BAYFERROX 8600™, 8610™; Northern Pigments magnetites, NP-604™, NP-608™; Magnox magnetites TMB-100™ or TMB-104™; and the like. As colored pigments, there can be selected cyan, magenta, yellow, red, green, brown, blue or mixtures thereof. Generally, cyan, magenta or yellow pigments or dyes or mixtures thereof, are used. The pigment or pigments are generally used as water-based pigment dispersions.

In embodiments, the colorant may include a pigment, a dye, combinations thereof, carbon black, magnetite, black, cyan, magenta, yellow, red, green, blue, brown, combinations thereof, in an amount sufficient to impart the desired color to the toner. It is to be understood that other useful colorants will become readily apparent based on the present disclosures.

Wax

Optionally, a wax may also be combined with the resin and an optional colorant in forming toner particles. The wax may be provided in a wax dispersion, which may include a single type of wax or a mixture of two or more different waxes. A single wax may be added to toner formulations, for example, to improve particular toner properties, such as, toner particle shape, presence and amount of wax on the toner particle surface, charging and/or fusing characteristics, gloss, stripping, offset properties and the like. Alternatively, a combination of waxes can be added to provide multiple properties to the toner composition.

When included, the wax may be present in an amount of, for example, from about 1% by weight to about 25% by weight of the toner particles, from about 5% by weight to about 20% by weight of the toner particles, although the amount of wax can be outside of those ranges.

When a wax dispersion is used, the wax dispersion may include any of the various waxes conventionally used in emulsion aggregation toner compositions. Waxes that may be selected include waxes having, for example, an average molecular weight of from about 500 to about 20,000, from about 1,000 to about 10,000. Waxes that may be used include, for example, polyolefins, such as, polyethylene including linear polyethylene waxes and branched polyethylene waxes, polypropylene including linear polypropylene waxes and branched polypropylene waxes, polyethylene/amide, polyethylenetetrafluoroethylene, polyethylenetetrafluoroethylene/amide, naturally occurring waxes such as those obtained from plant sources or animal sources, and polybutene waxes. Mixtures and combinations of the foregoing waxes may also be used, in embodiments. In embodiments, the waxes may be crystalline or non-crystalline.

In embodiments, the wax may be incorporated into the toner in the form of one or more aqueous emulsions or dispersions of solid wax in water, where the solid wax particle size may be in the range of from about 100 to about 500 nm.

Toner Preparation

The toner particles may be prepared by any method within the purview of one skilled in the art. Although embodiments relating to toner particle production are described below with respect to emulsion aggregation processes, any suitable method of preparing toner particles may be used, including, chemical processes, such as, suspension and encapsulation processes disclosed in U.S. Pat. Nos. 5,290,654 and 5,302,486, the disclosure of each of which hereby is incorporated by reference in entirety. In embodiments, toner compositions and toner particles may be prepared by aggregation and coalescence processes in which smaller-sized resin particles are aggregated to the appropriate toner particle size and then coalesced to achieve the final toner particle shape and morphology.

In embodiments, toner compositions may be prepared by emulsion aggregation processes, such as, a process that includes aggregating a mixture of an optional colorant, an optional wax and any other desired or required additives, and emulsions including the resins described above, optionally in surfactants as described above, and then coalescing the aggregate mixture. A mixture may be prepared by adding a colorant and optionally a wax or other materials, which may also be optionally in a dispersion(s) including a surfactant, to the emulsion, which may be a mixture of two or more emulsions containing the resin. The pH of the resulting mixture may be adjusted by an acid such as, for example, acetic acid, nitric acid or the like. The pH of the mixture may be adjusted to from about 2 to about 5. Additionally, in embodiments, the mixture may be homogenized. If the mixture is homogenized, that may be by mixing at about 600 to about 6,000 rpm. Homogenization may be accomplished by any suitable means, including, for example, an IKA ULTRA TURRAX T50 probe homogenizer.

Following the preparation of the above mixture, an aggregating agent may be added to the mixture. Any suitable aggregating agent may be utilized to form a toner. Suitable aggregating agents include, for example, aqueous solutions of a divalent cation or a multivalent cation material. The aggregating agent may be, for example, an inorganic cationic aggregating agent, such as, polyaluminum halides, such as, polyaluminum chloride (PAC), or the corresponding bromide, fluoride or iodide, polyaluminum silicates, such as, polyaluminum sulfosilicate (PASS), and water soluble metal salts, including aluminum chloride, aluminum nitrite, aluminum sulfate, potassium aluminum sulfate, calcium acetate, calcium chloride, calcium nitrite, calcium oxylate, calcium sulfate, magnesium acetate, magnesium nitrate, magnesium sulfate, zinc acetate, zinc nitrate, zinc sulfate, zinc chloride, zinc bromide, magnesium bromide, copper chloride, copper sulfate and combinations thereof. In embodiments, the aggregating agent may be added to the mixture at a temperatures that is below the Tg of the resin.

Suitable examples of organic cationic aggregating agents include, for example, dialkyl benzenealkyl ammonium chloride, lauryl trimethyl ammonium chloride, alkylbenzyl methyl ammonium chloride, alkyl benzyl dimethyl ammonium bromide, benzalkonium chloride, cetylpyridinium bromide, C₁₂C₁₅C₁₇-trimethyl ammonium bromides, halide salts of quaternized polyoxyethylalkylamines, dodecylbenzyl triethyl ammonium chloride, combinations thereof and the like.

Other suitable aggregating agents also include, but are not limited to, tetraalkyl titinates, dialkyltin oxide, tetraalkyltin oxide hydroxide, dialkyltin oxide hydroxide, aluminum alkoxides, alkyl zinc dialkyl zinc, zinc oxides, stannous oxide, dibutyltin oxide, dibutyltin oxide hydroxide, tetraalkyl tin, combinations thereof and the like. Where the aggregating agent is a polyion aggregating agent, the agent may have any desired number of polyion atoms present. For example, suitable polyaluminum compounds have from about 2 to about 13, from about 3 to about 8, aluminum ions present in the compound.

The aggregating agent may be added to the mixture utilized to form a toner in an amount of, for example, from about 0.1% to about 10% by weight, from about 0.2% to about 8% by weight, from about 0.3% to about 5% by weight, of the resin in the mixture.

The particles may be permitted to aggregate until a predetermined desired particle size is obtained. Particle size can be monitored during the growth process, for example with a COULTER COUNTER, for average particle size. The aggregation may proceed by maintaining the elevated temperature, or slowly raising the temperature to, for example, from about 40° C. to about 100° C., and holding the mixture at that temperature for a time of from about 0.5 hours to about 6 hours, from about 1 hour to about 5 hours, while maintaining stirring, to provide the aggregated particles. Once the desired size is reached, an optional shell resin can be added.

Once the desired final size of the toner particles is achieved, the pH of the mixture may be adjusted with a base to a value of from about 3 to about 10, from about 5 to about 9. The adjustment of the pH may be utilized to freeze, that is, to stop, toner particle growth. The base utilized to stop toner growth may include any suitable base such as, for example, alkali metal hydroxides, such as, for example, sodium hydroxide, potassium hydroxide, ammonium hydroxide, combinations thereof and the like. In embodiments, a chelator, such as, ethylene diamine tetraacetic acid (EDTA), may be added to help adjust the pH to the desired values noted above.

Shell Resin

In embodiments, after aggregation, but prior to coalescence, a resin coating may be applied to the aggregated particles to form a shell thereover. In embodiments, the core may thus include an amorphous resin and/or a crystalline resin, as described above. Any resin described above may be utilized as the shell.

Multiple resins may be utilized in any suitable amounts. Thus, a first resin may be present in an amount of from about 20% by weight to about 100% by weight of the total shell resin, from about 30% by weight to about 90% by weight of the total shell resin. In embodiments, a second resin may be present in the shell resin in an amount of from about 0 percent by weight to about 80 percent by weight of the total shell resin, from about 10 percent by weight to about 70 percent by weight of the shell resin.

The shell resin may be applied to the aggregated particles by any method within the purview of those skilled in the art. In embodiments, the resins utilized to form the shell may be in an emulsion, including any surfactant described above. The emulsion possessing the resins, optionally the solvent-based resin latex neutralized with NaOH described above, may be combined with the aggregated particles described above so that the shell forms over the aggregated particles.

The formation of the shell over the aggregated particles may occur while heating to a temperature of from about 30° C. to about 80° C., from about 35° C. to about 70° C. Formation of the shell may take place for a period of time of from about 5 min to about 10 hr, from about 10 minutes to about 5 hours.

The shell may be present in an amount of from about 10% by weight to about 40% by weight of the latex particles, from about 20% by weight to about 35% by weight of the latex particles.

In embodiments, the final size of the toner particles may be less than about 8 μm, less than about 7 μm, less than about 6 μm in size.

Coalescence

Following aggregation to the desired particle size and application of any optional shell, the particles may then be coalesced to the desired final shape, the coalescence being achieved by, for example, heating the mixture to a temperature of from about 45° C. to about 100° C., from about 55° C. to about 99° C., which may be at or above the Tg of the resin(s) utilized to form the toner particles. Coalescence may be accomplished over a period of from about 0.01 to about 9 hours, from about 0.1 to about 4 hours.

After aggregation and/or coalescence, the mixture may be cooled to room temperature, such as, from about 20° C. to about 25° C. The cooling may be rapid or slow, as desired. A suitable cooling method may include introducing cold water to a jacket around the reactor. After cooling, the toner particles may be optionally washed with water and then dried. Drying may be accomplished by any suitable method for drying, including, for example, freeze-drying.

Additives

In embodiments, the toner particles may contain other optional additives, as desired or required. For example, the toner may include positive or negative charge control agents, for example, in an amount of from about 0.1 to about 10% by weight of the toner, from about 1 to about 3% by weight of the toner. Examples of suitable charge control agents include quaternary ammonium compounds inclusive of alkyl pyridinium halides; bisulfates; alkyl pyridinium compounds, including those disclosed in U.S. Pat. No. 4,298,672, the disclosure of which is hereby incorporated by reference in entirety; organic sulfate and sulfonate compositions, including those disclosed in U.S. Pat. No. 4,338,390, the disclosure of which is hereby incorporated by reference in entirety; cetyl pyridinium tetrafluoroborates; distearyl dimethyl ammonium methyl sulfate; aluminum salts, such as, BONTRON E84™ or E88™ (Orient Chemical Industries, Ltd.); combinations thereof and the like.

There can also be blended with the toner particles external additive particles after formation including flow aid additives, which additives may be present on the surface of the toner particles. Examples of the additives include metal oxides, such as, titanium oxide, silicon oxide, aluminum oxides, cerium oxides, tin oxide, mixtures thereof and the like; colloidal and amorphous silicas, such as, AEROSIL®, metal salts and metal salts of fatty acids inclusive of zinc stearate and calcium stearate, or long chain alcohols, such as, UNILIN 700, and mixtures thereof.

In general, silica may be applied to the toner surface for toner flow, tribo enhancement, admix control, improved development and transfer stability, and higher toner blocking temperature. TiO₂ may be applied for improved relative humidity (RH) stability, tribo control and improved development and transfer stability. Zinc stearate, calcium stearate and/or magnesium stearate may be used as an external additive for providing lubricating properties, developer conductivity, tribo enhancement and enabling higher toner charge and charge stability by increasing the number of contacts between toner and carrier particles. In embodiments, a commercially available zinc stearate known as Zinc Stearate L, obtained from Ferro Corp., may be used. The external surface additives may be used with or without a coating.

Each of the external additives may be present in an amount of from about 0.1% by weight to about 5% by weight of the toner, from about 0.25% by weight to about 3% by weight of the toner, although the amount of additives can be outside of those ranges. In embodiments, the toners may include, for example, from about 0.1% by weight to about 5% by weight titania, from about 0.1% by weight to about 8% by weight silica and from about 0.1% by weight to about 4% by weight zinc stearate.

Suitable additives include those disclosed in U.S. Pat. Nos. 3,590,000, 3,800,588 and 6,214,507, the disclosure of each of which hereby is incorporated by reference in entirety.

In embodiments, toners of the present disclosure may be utilized as ultra low melt (ULM) toners.

In embodiments, the dry toner particles having a shell of the present disclosure may, exclusive of external surface additives, have the following characteristics: (1) volume average diameter (also referred to as “volume average particle diameter”) of from about 3 to about 25 μm, from about 4 to about 15 μm, from about 5 to about 12 μm; (2) number average geometric size distribution (GSDn) and/or volume average geometric size distribution (GSDν) of from about 1.05 to about 1.55, from about 1.1 to about 1.4; and (3) circularity of from about 0.93 to about 1, in embodiments, from about 0.95 to about 0.99 (as measured with, for example, A Sysmex FPIA 2100 analyzer).

The characteristics of toner particles may be determined by any suitable technique and apparatus, such as, a Beckman Coulter MULTISIZER 3.

The subject matter now will be exemplified in the following non-limiting examples. Parts and percentages are by weight unless otherwise indicated. As used herein, “room temperature,” (RT) refers to a temperature of from about 20° C. to about 30° C.

### EXAMPLES

### Example 1

### PIE Simulation

Six parts MEK, 1.8 parts of IPA, 10 parts of polyester resin and 6.25 parts of water (first portion) were added to promote polyester dissolution in dual solvents. After neutralization of the polyester comprising a high molecular weight (HMW) amorphous resin (with 0.11 parts of aqueous ammonia), a second portion of water, 13.74 parts, was added slowly to convert the resin dissolution into latex at 40° C. Table 1 lists the components and relative amounts of the formulation. It can be seen that phase inversion occurred at about 52% water.

TABLE 1
The solvent reuse formulation.

| Chemicals | Parts | Percentage (%) |
|---|---|---|
| HMW Amorphous Resin | 10 | 26.2 |
| Methyl Ethyl Ketone (MEK) | 6 | 15.7 |
| Isopropyl Alcohol (IPA) | 1.8 | 4.7 |
| Aqueous Ammonia (First) | 0.11 | 0.3 |
| DI Water (First) | 6.25 | 16.4 |
| Aqueous Ammonia (Second) | 0.22 | 0.6 |
| DI Water (Second) | 13.74 | 36.0 |
| Total | 38.12 | 100 |

Thereafter, the water fraction at the PIP was calculated using the formulae disclosed herein. At maximum viscosity, the interface tension of the oil continuous phase is equivalent to the water continuous phase. At that point, phase inversion occurs and that data point provides the water fraction or amount at which inversion occurs. The calculated PIP was 52%, in agreement with the data presented by reagent amount in Table 1. Subsequently, the viscosity decreases with continued addition of water, and water eventually becomes the continuous phase in the latex system.

During this PIE process, it was found that both the particle size and size distribution become stable (at about 202±3 nm) after PIP, which refers to the water fraction for phase inversion to take place and conversion of the resin dissolution to latex.

### Example 2

### Phase Inversion of Amorphous Resin

MEK (240 g), 72 g IPA, 4.4 g ammonia NH₄OH (first portion) and 250 g DI water (first portion) were weighed out and charged in a 3 L flask under 200 rpm to form a mixture. Four hundred g of amorphous resin with an acid value of 12.3 were added into the flask with 400 rpm for dissolution. The batch temperature was set at 42° C. After 2 hours, the resin was dissolved fully and another 8.8 g 10% NH₄OH solution were added to the resin dispersion within 2 min. The neutralization ratio was calculated as 10% NH₃, and the amount of 10% NH₃ in parts was calculated based on the following equation:

10% NH₃=neutralization ratio*amount of resin in parts*AV*0.303*0.01.

Ten parts resin was used for each formulation and AV is the acid value of the resin. The values, 0.303 and 0.01, are constants calculated based on the ratio of molecular weights between ammonia and KOH and solution weight corresponding to 10% ammonia concentration, respectively. A neutralization ratio of 90% was used in the example. The mixture was left to stir for 10 minutes, then 550 g of DI water (second portion of water) at room temperature was pumped into the flask at a flow rate of 10 g/min. The PIE process was completed within 55 min at 600 rpm. Table 2 lists the particle size and size distribution measured by Nanotrac during addition of water.

TABLE 2
Latex particle size and distrubution as a function of water fraction

| | Water | | | |
|---|---|---|---|---|
| Time (min) | Fraction (%) | D₅₀ (nm) | D₉₅ (nm) | Width (nm) |
| 17 | 52.5 | 464 | 5880 | 1000 |
| 21 | 57.5 | 196.3 | 334 | 110 |
| 26 | 64 | 190.6 | 311 | 100 |
| 35 | 75 | 193.8 | 301 | 100 |
| 44 | 86 | 195.2 | 306 | 100 |
| 55 | 100 | 186.6 | 297.5 | 100 |

At about 52.5% water, phase inversion took place and latex particles were generated with a trimodal distribution of particles with modal sizes of 327 nm, 1698 nm and 5960 nm. The particle size distribution was broad. However, after another 4 min of water addition to 57.5% water, the particle size decreased significantly and the distribution became unimodal at 197 nm. Addition of the rest of the water did not result in remarkable variation of particle size, the particle size at each water fraction was consistent with narrow particle size distribution. While not being bound by theory, that suggests that the particle is stable after the PIP, which allows for reduction in cycle time by increasing the water addition process.

### Example 3

### Phase Inversion of HMW Amorphous Resin

The same formulation and procedure were used to prepare a batch of latex. After the resin was dissolved in the solvent mixture (MEK, IPA, and the first part of DI water) and neutralized by ammonia, the second part of DI water was fed into the mixture with a fixed flow ratio to generate latex. The sample at 60% of water fraction had a particle size of 213 nm. Then, the rest of the water (40%) was fed into the reactor within 1 minute to make the DI water content at 100% in that latex batch. The final particle size at 100% water fraction was 210 nm. While not being bound by theory, that suggests that the quick addition of water into the latex batch after PIP will not affect the final latex particle size and the cycle time is reduced by taking advantage of the PIE process characteristic.

As shown above, the method allows for improved productivity by completing phase inversion with about 57% water addition and feeding the rest of the water as fast as possible to complete the emulsification process. Cycling time was reduced by about 35 minutes from phase inversion, leading to a 20% savings in total emulsification process (2 hours dissolution plus 1 hour phase inversion: total 3 hours cycling time). The process also may be used to maximize batch capacity by minimizing the water needed to complete phase inversion and obtaining higher yield with increased solid content, resulting in more space for combining two or more batches in one reactor. The rest of the water may be added during batch splitting.

It will be appreciated that various of the above-disclosed and other features and functions, or alternatives thereof, may be desirably combined into many other different systems or applications. Also various presently unforeseen or unanticipated alternatives, modifications, variations or improvements therein may be subsequently made by those skilled in the art, which are also intended to be encompassed by the following claims. Unless specifically recited in a claim, steps or components of claims should not be implied or imported from the specification or any other claims as to any particular order, number, position, size, shape angle, color or material.

All references cited herein are incorporated by reference in entirety.

We claim:

1. A method of phase inversion emulsification (PIE) comprising:
a) combining a resin, an organic solvent, an optional first portion of a neutralizing agent and a first portion of water to form a water-in-oil (W/O) dispersion mixture;
b) determining an amount of a second portion of water to add to the mixture to effect phase inversion by:
(i) calculating the Viscosity Blending Number or Index (VBN) for each component of the mixture using equation 1 (eq. 1):
VBN=14.534×1n [1n(ν+0.8)]+10.975 (eq. 1),
wherein ν is the kinematic viscosity in centistokes (cSt);
(ii) calculating the VBN of the mixture using equation 2 (eq. 2):
VBNₘᵢₓₜᵤᵣₑ=[X_{A}×VBN_{A}]+[X_{B}×VBN_{B}]+ . . . [X_{N}×VBN_{N}] (eq. 2),
where X is the mass fraction of each component of the mixture,
(iii) calculating the kinematic viscosity of the blend by solving eq. 1 for ν resulting in equation 3 (eq. 3), and
$$v = exp ( exp ( \frac{{VEN}_{mixture} - \text{?}}{\text{?}} ) ) - 0.8 , \\ \text{?} \text{indicates text missing or illegible when filed} \qquad ( eq . 3 )$$
(iv) calculating the water fraction at the maximum VBNₘᵢₓₜᵤᵣₑ for the mixture using equation 4 (eq. 4);
$$\text{?} = \text{?} , \\ \text{?} \text{indicates text missing or illegible when filed} \qquad ( eq . 4 )$$
wherein μ_{φ} is the viscosity of the dispersed phase of the mixture, μ_{c} is the viscosity of the continuous phase of the mixture, which is equal to the VBNₘᵢₓₜᵤᵣₑ, and Φ is the water fraction of the mixture, and where Φ is the sum of the first portion of water, any water portion of the optional neutralizing agent and a second portion of water, where the water fraction is the amount of water in the mixture to attain the phase invention point (PIP) for the mixture; and
c) adding the second portion of water to the mixture to convert the W/O dispersion mixture comprising the resin into an oil-in-water (O/W) dispersion comprising a latex emulsion.

2. The method of claim 1, wherein the first portion of water is present at an amount of up to about 80% of the amount of the at least two organic solvents.

3. The method of claim 1, wherein the kinematic viscosity of each component is obtained at the same temperature.

4. The method of claim 1, wherein the particle size distribution of the resin is multimodal below the PIP, and wherein the particle size distribution of the latex emulsion is unimodal at or above the PIP.

5. The method of claim 4, wherein once the calculated the Φ is reached, increased water fraction does not substantially change particle size or particle size distribution of the latex emulsion.

6. The method of claim 1, wherein said resin comprises a polyester polymer.

7. The method of claim 1, wherein said solvent is selected from the group consisting of methanol, ethanol, isopropanol, butanol, ethylene glycol, glycerol, sorbitol, acetone, 2-butanone, 2-pentanone, 3-pentanone, ethyl isopropyl ketone, methyl isobutyl ketone, diisobutyl ketone, methyl ethyl ketone, dimethylformamide, dimethylacetamide, N-methylpyrrolidone, 1,2-dimethyl-2-imidazolidinone, acetonitrile, propionitrile, butyronitrile, isobutyronitrile, valeronitrile, benzonitrile, ditertbutyl ether, dimethoxyethane, 2-methoxyethyl ether, 1,4-dioxane, tetrahydrohyran, morpholine, methylsulfonylmethane, sulfolane, dimethylsulfoxide, hexamethylphosphoramide, benzenes esters and amines.

8. The method of claim 1, wherein resin and solvent are present in a ratio from about 10:7 to about 10:20 (wt:wt).

9. The method of claim 1, comprising at least two organic solvents.

10. The method of claim 1, further comprising adding a portion of a neutralizing agent before addition of the second portion of water.

11. The method of claim 10, wherein the first and second neutralizing agent are selected from the group consisting of ammonium hydroxide, potassium hydroxide, sodium hydroxide, sodium carbonate, sodium bicarbonate, lithium hydroxide, potassium carbonate, potassium bicarbonate, secondary amines, which include aziridines, azetidines, piperazines, piperidines, pyridines, bipyridines, terpyridines, dihydropyridines, morpholines, N-alkylmorpholines, 1,4-diazabicyclo[2.2.2]octanes, 1,8-diazabicycloundecanes, 1,8-diazabicycloundecenes, dimethylated pentylamines, trimethylated pentylamines, pyrimidines, pyrroles, pyrrolidines, pyrrolidinones, indoles, indolines, indanones, benzindazones, imidazoles, benzimidazoles, imidazolones, imidazolines, oxazoles, isoxazoles, oxazolines, oxadiazoles, thiadiazoles, carbazoles, quinolines, isoquinolines, naphthyridines, triazines, triazoles, tetrazoles, pyrazoles, pyrazolines, and combinations thereof.

12. A method of preparing a toner comprising:
a) combining a resin, an organic solvent, an optional first portion of a neutralizing agent, and a first portion of water to form a water-in-oil (W/O) dispersion mixture;
b) determining an amount of a second portion of water to add to the mixture to effect phase inversion by:
(i) calculating the Viscosity Blending Number or Index (VBN) for each component of the mixture using equation 1 (eq. 1):
VBN=14.534×1n [1n(ν+0.8)]+10.975 (eq. 1),
wherein ν is the kinematic viscosity in centistokes (cSt);
(ii) calculating the VBN of the mixture using equation 2 (eq. 2):
VBNₘᵢₓₜᵤᵣₑ=[X_{A}×VBN_{A}]+[X_{B}×VBN_{B}]+ . . . [X_{N}×VBN_{N}] (eq. 2),
where X is the mass fraction of each component of the mixture,
(iii) calculating the kinematic viscosity of the blend by solving eq. 1 for ν resulting in equation 3 (eq. 3), and
$$v = exp ( exp ( \frac{{VEN}_{mixture} - \text{?}}{\text{?}} ) ) - 0.8 , \\ \text{?} \text{indicates text missing or illegible when filed} \qquad ( eq . 3 )$$
(iv) calculating the water fraction at the maximum VBNₘᵢₓₜᵤᵣₑ for the mixture using equation 4 (eq. 4);
$$\text{?} = \text{?} , \\ \text{?} \text{indicates text missing or illegible when filed} \qquad ( eq . 4 )$$
wherein μ_{φ} is the viscosity of the dispersed phase of the mixture, μ_{c} is the viscosity of the continuous phase of the mixture, which is equal to the VBNₘᵢₓₜᵤᵣₑ, and Φ is the water fraction of the mixture, and where Φ is the sum of the first portion of water, any water portion of the optional neutralizing agent and a second portion of water, where the water fraction is the amount of water in the mixture to attain the phase invention point (PIP) for the mixture; and
c) adding the second portion of water to the mixture to convert the W/O dispersion mixture comprising the resin into an oil-in-water dispersion comprising a latex emulsion;
d) adding an optional at least a second resin to said emulsion;
e) optionally adding a crystalline resin to said emulsion;
f) optionally adding a wax, a colorant or both to said emulsion;
g) optionally adding a flocculent to the emulsion;
h) aggregating particles in said emulsion;
i) freezing particle growth in said emulsion to form frozen particles;
j) optionally adding a shell resin to said frozen particles;
k) optionally coalescing said frozen particles in said emulsion to form toner particles; and
l) collecting said frozen particles or said toner particles from said emulsion.

13. The method of claim 12, wherein the first portion of water is present at an amount of up to about 80% of the amount of the organic solvent.

14. The method of claim 12, wherein the kinematic viscosity of each component is obtained at the same temperature.

15. The method of claim 12, wherein the particle size distribution of the resin is multimodal below the PIP, and wherein the particle size distribution of the latex emulsion is unimodal at or above the PIP.

16. The method of claim 15, wherein once the calculated the Φ is reached, increased water fraction does not substantially change the particle size or particle size distribution of the latex emulsion.

17. The method of claim 12, wherein said resin comprises a polyester polymer.

18. The method of claim 12, wherein said solvent is selected from the group consisting of methanol, ethanol, isopropanol, butanol, ethylene glycol, glycerol, sorbitol, acetone, 2-butanone, 2-pentanone, 3-pentanone, ethyl isopropyl ketone, methyl isobutyl ketone, diisobutyl ketone, methyl ethyl ketone, dimethylformamide, dimethylacetamide, N-methylpyrrolidone, 1,2-dimethyl-2-imidazolidinone, acetonitrile, propionitrile, butyronitrile, isobutyronitrile, valeronitrile, benzonitrile, ditertbutyl ether, dimethoxyethane, 2-methoxyethyl ether, 1,4-dioxane, tetrahydrohyran, morpholine, methylsulfonylmethane, sulfolane, dimethylsulfoxide, hexamethylphosphoramide, benzenes esters and amines.

19. The method of claim 12, wherein resin and solvent are present in a ratio from about 10:7 to about 10:20 (wt:wt).

20. The method of claim 12, comprising at least two organic solvents.
